(19) United States
(12) Patent Application Publication
(10) Pub. No.: US 2014/0075335 A1
(43) Pub. Date: Mar. 13, 2014

(54) IMAGE EDITING AND SHARING

(71) Applicants: Colton Bryant Hicks, Provo, UT (US); Samuel David Stapp, Alpine, UT (US); Alma T. Madsen, Lehi, UT (US); Karl Sun, Draper, UT (US)

(72) Inventors: Colton Bryant Hicks, Provo, UT (US); Samuel David Stapp, Alpine, UT (US); Alma T. Madsen, Lehi, UT (US); Karl Sun, Draper, UT (US)

(73) Assignee: LUCID SOFTWARE, INC., Draper, UT (US)

(21) Appl. No.: 13/610,540

(22) Filed: Sep. 11, 2012

(51) Int. Cl. H04L 29/06

(52) U.S. Cl. CPC H04L 65/403
USPC 715/753

(57) ABSTRACT

In an embodiment, a method of editing and sharing images is described. The method may include pulling an image from a source location into a browser executing on a client device. The method may additionally include editing the image within the browser. The method may additionally include sharing the edited image from the browser to a social network accessible to the client device.

### FIELD

Some embodiments described herein generally relate to editing and sharing images.

### BACKGROUND

Various editing applications, such as ADOBE PHOTOSHOP, exist for editing photos and other images. Images available on the Internet can be viewed in an Internet browser. To edit images available on the Internet that are not otherwise locally available to a client device running the browser, users typically have to navigate the browser to a website where a desired image is available and use the browser to save the image locally. The locally saved image can then be opened and edited in the editing application, followed by locally saving the resulting edited image. To share the edited image over the Internet, if so desired, the browser has to be navigated by the user to a website where the edited image can be shared, and then the edited image has to be manually selected and uploaded to the website.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Some example embodiments described herein generally relate to techniques for editing and sharing images.

In an example embodiment, a method of editing and sharing images is described. The method may include pulling an image from a source location into a browser executing on a client device. The method may additionally include editing the image within the browser. The method may additionally include sharing the edited image from the browser to a social network accessible to the client device.

In another example embodiment, another method of editing and sharing images is described. The method may include receiving a request from a browser on a client device to edit an image included in a first website rendered by the browser. The request includes a Uniform Resource Identifier (URI) of the first website and an identifier of the image. The method also includes retrieving the image from the first website using the URI and the identifier. The method also includes saving the image. The method also includes redirecting the browser to a second website including the image and a browser-based user interface for editing the image, wherein the image is edited at the client device in the browser. The method also includes receiving the edited image from the browser on the client device. The method also includes saving the edited image at an image server.

In another example embodiment, a method of creating visual conversations is described. The method may include receiving an image from a first user. The method may also include sharing the image with other users. The method may also include receiving a visual comment stream for the image from at least some of the other users. The visual comment stream may include at least one edited image corresponding to the image. The method may also include sharing the visual comment stream with the users.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment including one or more image source locations and one or more client devices configured to edit images from the image source location;

FIG. 2 shows an example flow diagram of a method of editing and sharing images that may be performed by a client device;

FIG. 3A shows an example flow diagram of a method of editing and sharing images that may be performed by an image server;

FIG. 3B shows an example flow diagram of a method of creating visual conversations;

FIGS. 4A-4F include a first set of screenshots that illustrate aspects of a specific embodiment of the methods of FIGS. 2-3B;

FIGS. 5A-5F include a second set of screenshots that illustrate aspects of another specific embodiment of the methods of FIGS. 2-3B; and

FIG. 6 is a block diagram illustrating an example computing device that is arranged for editing and sharing images.

### DETAILED DESCRIPTION OF SOME EXAMPLE EMBODIMENTS

Embodiments described herein generally relate to techniques for editing and sharing images. The images may be edited in a browser-based user interface (UI), a native app on a smartphone or other mobile device, or other suitable application. For example, a browser (or app) on a client device may be used to view one or more images from an image source location, such as a first website. User input is provided to request that one of the images be edited. The request is sent to an image server that retrieves the image and redirects the browser to a second website hosted by the image server. The second website includes the image and the browser-based UI for editing the image. Thus, the image may be pulled from the first website into the browser for editing. The image is edited in the browser in response to user input to generate an edited image. The edited image may then be shared with a social network, such as by reposting the edited image to the first website when the first website is part of a social network, or by posting the edited image to a social network unassociated with the first website when the first website is not part of a social network.

Accordingly, some embodiments described herein allow images to be edited in a browser without manually saving the image locally to the client device, opening the image in a different editing application, editing the image in the different editing application, and saving the edited image. Further, some embodiments described herein allow the edited image to be shared to a social network with the click of a button from the browser in which the edited image is created, rather than manually selecting and uploading the edited image saved using the different editing application.

Moreover, the ability to edit and share images allows members of social networks to engage in relatively more artistic and visual comment streams than can occur where the members are unable—or unwilling due to the effort involved—to provide anything beyond textual comments in association with original images uploaded or otherwise shared by the members. For instance, a first member may edit and share an image to a social network. Other members that view the edited image may re-edit and share the original image and/or the edited image in a visual conversation between the members, as opposed to just a series of textual comments in association with the original image as occurs in some social networks.

Reference will now be made to the drawings to describe various aspects of some example embodiments of the invention. The drawings are diagrammatic and schematic representations of such example embodiments, and are not limiting of the present invention, nor are they necessarily drawn to scale.

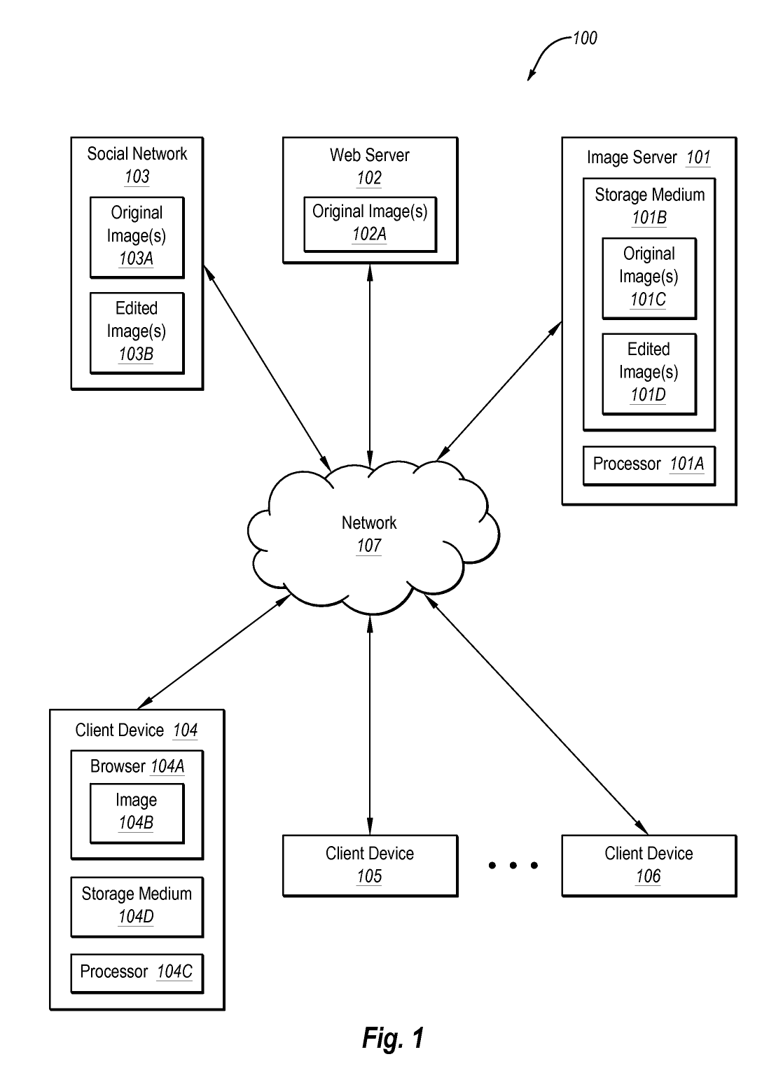

FIG. 1 is a block diagram of an example operating environment 100 including one or more image source locations 101-103 (hereinafter “source locations 101-103) and one or more client devices 104-106 configured to edit images from any of the source locations, arranged in accordance with at least some embodiments described herein. The images may have any suitable format such as, but not limited to, Joint Photographic Experts Group (JPEG) format, JPEG File Interchange Format (JFIF), JPEG 2000 format, Exchangeable image file format (Exif), Tagged Image File Format (TIFF), Portable Network Graphics (PNG) file format, Graphics Interchange Format (GIF), BMP file format, portable pixmap (PPM) file format, portable graymap (PGM) file format, portable bitmap (PBM) file format, Computer Graphics Metafile (CGM) file format, RS-274X Extended Gerber Format, and Scalable Vector Graphics (SVG) format.

The operating environment may additionally include a network 107. In general, the network 107 may include one or more wide area networks (WANs) and/or local area networks (LANs) that enable the source locations 101-103 and the client devices 104-106 to communicate with each other. In some embodiments, the network 107 includes the Internet, including a global internetwork formed by logical and physical connections between multiple WANs and/or LANs. Alternately or additionally, the network 107 may include one or more cellular RF networks and/or one or more wired and/or wireless networks such as, but not limited to, 802.xx networks, Bluetooth access points, wireless access points, IP-based networks, or the like. The network 107 may also include servers that enable one type of network to interface with another type of network.

Each of the client devices 104-106 may execute an application, such as a browser 104A, configured to communicate through the network 107 with the source locations 101-103. Each of the other client devices 105-106 may be similarly configured to execute a browser, such as the browser 104A. The browser 104A may include an Internet browser or other suitable application. The browser 104A may download and/or interact with content, such as websites including web pages, documents, and/or applications hosted by servers associated with the source locations 101-103 or other servers (not shown) in the operating environment 100. The content downloaded to and/or with which the browser 104A interacts may include images, such as an image 104B. For instance, a website including one or more web pages with one or more images available from any of the source locations 101-103 can be opened in the browser 104A. Each of the client devices 104-106 may include, but is not limited to, a desktop computer, a laptop computer, a tablet computer, a mobile phone, a smartphone, a personal digital assistant (PDA), or other suitable client device.

Embodiments described herein are not limited to using a browser to edit and share images. For example, rather than or in addition to a browser, the client devices 104-106 may include a native app as are often used on client devices such as mobile devices including smartphones and tablet computers. Accordingly, embodiments described herein generally include editing and sharing images using a browser, native app, or other suitable application.

Each of the client devices 104-106 may additionally include a processor and a storage medium, such as a processor 104C and a storage medium 104D as illustrated for the client device 104 in FIG. 1. Each of the other client devices 105-106 may be similarly configured. The processor 104C may be of any type including, but not limited to, a microprocessor (μP), a microcontroller (μC), a digital signal processor (DSP), or any combination thereof. The processor 104C may be configured to execute computer instructions that, when executed, cause the processor 104B to perform one or more of the operations described herein with respect to the client device 104 and/or the browser 104A.

The storage medium 104D may include volatile memory such as random access memory (RAM), persistent or non-volatile storage including, but not limited to, read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 104D may store computer instructions that may be executed by the processor 104C to perform one or more of the operations described herein with respect to the client device 104 and/or the browser 104A. The storage medium 104D may additionally store, at least temporarily, the image 104B and/or other content obtained from any of the source locations 101-103.

In the illustrated embodiment, the source locations 101-103 include an image server 101, a web server 102, and a social network 103. More or fewer source locations may be provided in other embodiments. Moreover, source locations are not limited to source locations that are remote from the client devices 104A. For example, embodiments described herein include storage that is local to the client devices 104-106, such as the storage medium 104D. Thus, the browser 104A (or an app) may pull in an image already stored in the storage medium 104D for editing and sharing as described herein. Whereas many mobile client devices such as smartphones and tablet computers include cameras, source locations may also include cameras. For example, a client device can capture an image using a camera, which image can then be edited and shared in the browser 104A (or an app) as described herein.

For convenience in the discussion that follows, the editing and sharing of images is discussed as being performed on images obtained from source locations 101-103 that are remote from the client devices 104-106 and by a browser such as the browser 104D. It is understood, however, with the benefit of the present disclosure, that the source locations of the images may instead be local, such as the storage medium 104D or a camera of the client devices 104-106, and that the editing and sharing may be done on the client devices 104-106 by a browser, native app, or other suitable application.

In general, the image server 101 is configured to cooperate with the client devices 104-106 to allow the client devices 104-106 to pull an image from any of the source locations 101-103 or other source locations (such as the storage medium 104D or a camera) into a corresponding browser (or app), such as the browser 104A, to edit the image, and to share the edited image with a social network, as described in further detail below.

The web server 102 is configured to host content such as websites including one or more images such as one or more original image(s) 102A. The original image(s) 102A may be pulled into a corresponding browser of the client devices 104-106 for editing and sharing. The edited images may be shared via the social network 103 or the image server 101, for instance.

In some embodiments, the web server 102 is unassociated with any social networks. Being unassociated with any social networks may mean that the web server 102 does not host any social networks.

The social network 103 can be any social network such as, but not limited to, Facebook, LinkedIn, Geni, Twitter, Pinterest, or other social network. Generally, the social network 103 may include one or more servers that host websites included in or otherwise associated with the social network 103. The servers of the social network 103 may additionally include various algorithms for connecting individuals, persons, entities, or other members of the social network 103, by levels of interdependency such that the members can connect to and/or “follow” each other.

The social network 103, and more particularly the websites hosted by the servers of the social network 103, may include one or more original image(s) 103A such as images that may be uploaded to the social network 103 by members of the social network 103, as well as images associated with advertisements, and the like. The original image(s) 103A may be pulled into a corresponding browser of the client devices 104-106 for editing and sharing. The social network 103 may additionally include the edited images, such as edited image(s) 103B.

The image server 101 includes a processor 101A and a storage medium 101B. Similar to the processor 104C of the client device 104, the processor 101A may be of any type including, but not limited to, a μP, a μC, a DSP, or any combination thereof. The processor 101A may be configured to execute computer instructions that, when executed, cause the processor 101A to perform one or more of the operations described herein with respect to the image server 101.

Similar to the storage medium 104D of the client device 104, the storage medium 101B may include volatile memory such as RAM, persistent or non-volatile storage including, but not limited to, ROM, EEPROM, CD-ROM or other optical disk storage, magnetic disk storage or other magnetic storage device, NAND flash memory or other solid state storage device, or other persistent or non-volatile computer storage medium. The storage medium 101B may store original image(s) 101C which, in some embodiments, correspond to original image(s) 102A, 103A selected at the client devices 104-106 for editing, and/or edited image(s) 101D initially generated at the client devices 104-106 by editing the selected original image(s) 102A, 103A. The storage medium 101B may additionally store computer instructions that may be executed by the processor 101A to perform one or more of the operations described herein with respect to the image server 101.

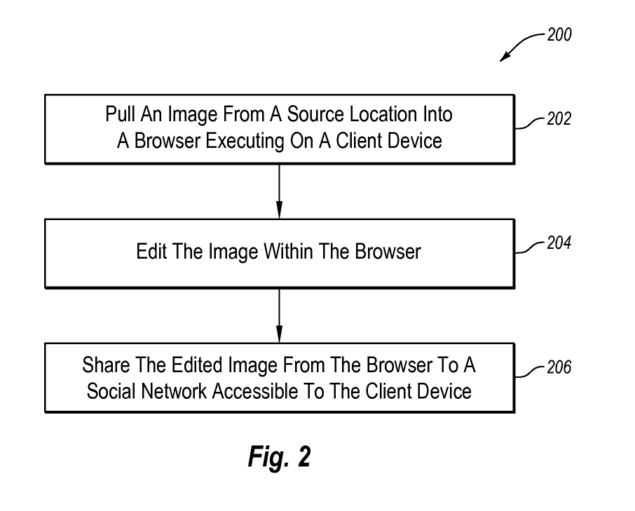

FIG. 2 shows an example flow diagram of a method 200 of editing and sharing images, arranged in accordance with at least some embodiments described herein. The method 200 may be performed in whole or in part by, e.g., any of the client devices 104-106 of FIG. 1. Although illustrated as discrete blocks, various blocks may be divided into additional blocks, combined into fewer blocks, or eliminated, depending on the desired implementation.

The method 200 may begin at block 202 in which an image is pulled from a source location into a browser executing on a client device. For example, a selected one of the original image(s) 102A or 103A may be pulled from the web server 102 or the social network 103 into the browser 104A on the client device 104. The source location may include a website including multiple edited images all corresponding to the image. In these and other embodiments, the edited images may be created by multiple users and may form a visual comment stream associated with the image.

Although not required, in some embodiments, the image may be pulled from a source location into a browser executing on a client device by a user dragging and dropping the image from the source location into a browser. For example, a user may drag an image from a local file system, or directly from another web page being rendered in a browser, and drop the image into the browser 104A on the client device 104.

In some embodiments, the image that is pulled from the source location may alternately or additionally include one of the edited image(s) 103B, 101D that has already been edited by one or more other users, or one of the original images 103A, 101C that has one or more edited images 103B, 101D associated therewith. A user operating the device performing the method 200 of FIG. 2 may decide to edit and share the image after seeing one or more edited images from other users. As such, the user can engage in a visual dialogue or conversation with other users by creating and sharing an edited image in response to edited image(s) previously created and shared by other user(s).

In block 204, the image may be edited within the browser. Editing the image may include adding a thought bubble, a speech bubble, text, a caption, a hashtag, a border, a mark representing user input such as freehand drawing, or a graphical object to the image, or the like or any combination thereof. Alternately or additionally, editing the image may include removing any of the foregoing, or modifying any of the foregoing. Alternately or additionally, editing the image may include obscuring a portion of the image, cropping the image, modifying an aspect ratio of the image, or the like or any combination thereof.

In block 206, the edited image may be shared from the browser to a social network accessible to the client device. The social network to which the edited image is shared may include the source location. For example, where the image pulled into the browser is one of the original image(s) 103A pulled from the social network 103, the edited image may include one of the edited image(s) 103B that is shared back to the social network 103. Alternately, the social network to which the edited image is shared may be a social network hosted by the image server 101. For example, where the image pulled into the browser is one of the original image(s) 102A (or 103A) pulled from the web server 102 (or the social network 103), the edited image may include one of the edited image(s) 101D that is shared via the social network hosted by the image server 101.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For example, the method 200 may further include, prior to pulling the image, rendering in the browser a website received from the source location where the website includes the image. User input effective to request that the image be edited may be received. The request may be communicated to an image server, such as the image server 101 of FIG. 1. The image server may be configured to save a first copy of the image and forward a second copy of the image to the client device.

In some embodiments, the image is a first image, the website is a first website, and the first website includes multiple images including the first image. The terms “first,” “second” and the like are used herein merely to distinguish different items, and do not necessarily indicate an order, ranking, or the like, unless context dictates otherwise. In these and other embodiments, receiving user input effective to request that the first image be edited may include receiving user input effective to run a JavaScript or other computer instructions. The JavaScript or other computer instructions may be configured, when executed, to identify the images and display representations of the images in the browser. For example, execution of the JavasScript may cause tiles or thumbnails of all of the images from the first website to be displayed in the browser. Accordingly, receiving user input effective to request that the first image be edited may additionally include receiving user input effective to select one of the representations corresponding to the first image and to redirect the browser from the source location (or the first website) to the image server.

The image server may send a second website to the client device such that the method 200 may additionally include receiving the second website from the image server. The second website may include the first image and a browser-based UI for editing the first image. The second website may be rendered in the browser. User input effective to edit the first image may be received, thereby causing the first image to be edited.

In some embodiments, a copy of the edited image may be sent to the image server for storage on the image server.

Some embodiments disclosed herein include an article of manufacture such as a computer storage medium having instructions stored thereon that are executable by a computing device to perform operations included in the method 200 of FIG. 2, such as the operations illustrated by blocks 202, 204 and/or 206 in FIG. 2, and/or variations thereof. The computer storage medium may be included in one or more of the client devices 104-106 of FIG. 1. The computing device may include any of the client devices 104-106, and/or a processor or other processing device of the client devices 104-106, such as the processor 104C.

As mentioned previously, embodiments described herein are not limited to using a browser to edit and share images. For example, a variant of the method 200 of FIG. 2 may include pulling an image from a source location into an application (such as a browser or a native app) executing on a client device; editing the image within the application; and sharing the edited application from the application to a social network accessible to the client. In these and other embodiments, the source location may include a remote source location such as the image server 101, the web server 102 or the social network 103, or a local location such as a local storage medium or a camera of the client device.

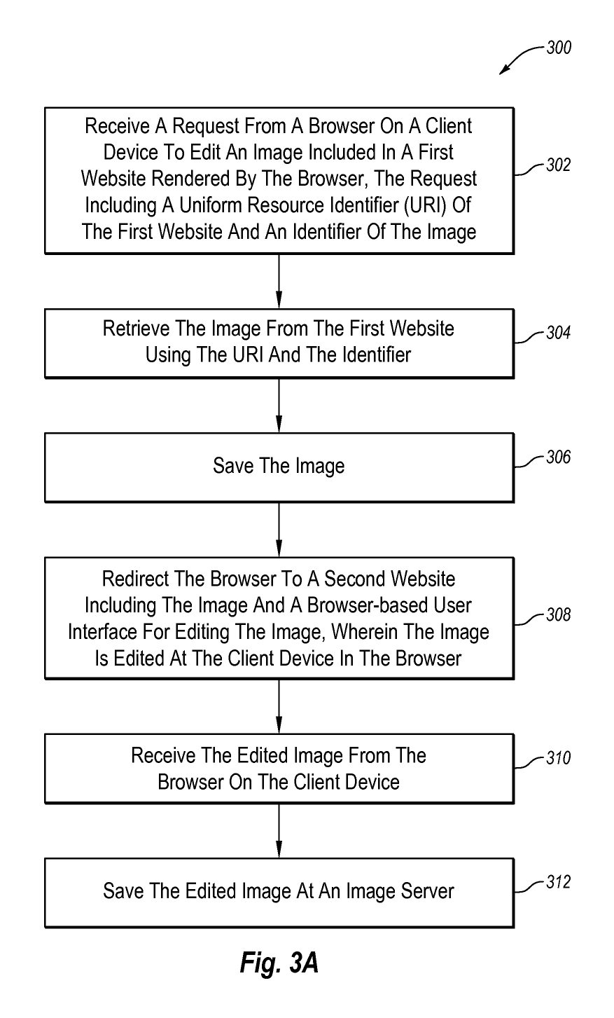

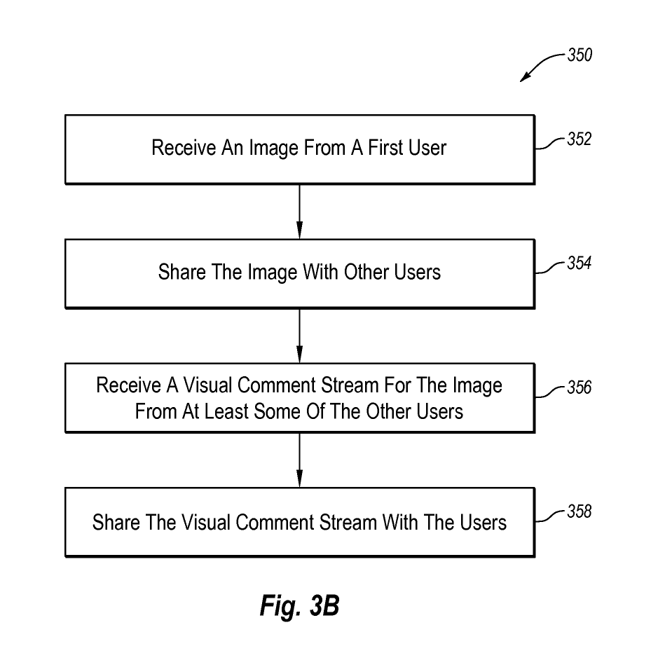

FIG. 3A shows an example flow diagram of another method 300 of editing and sharing images, arranged in accordance with at least some embodiments described herein. The method 300 may be performed in whole or in part by, e.g., the image server 101 of FIG. 1. Although illustrated as discrete blocks, various blocks may be divided into additional blocks, combined into fewer blocks, or eliminated, depending on the desired implementation.

The method 300 may begin at block 302 in which a request is received from a browser on a client device to edit an image included in a first website rendered by the browser. The request may include a URI of the first website and an identifier of the image. For example, the image server 101 may receive the request from the browser 104A after the browser 104A receives input effective to request that the image be edited as described above with respect to FIG. 2.

In block 304, the image is retrieved from the first website using the URI and the identifier.

In block 306, the image is saved. For example, the image may be saved at or in a location accessible to the image server. Saving the image allows the image server in some embodiments to provide the original image for editing by other users, rather than providing a previously edited image to other users.

In block 308, the browser is redirected to a second website including the image and a browser-based UI for editing the image. The image is edited at the client device in the browser, resulting in an edited image.

In block 310, the edited image is received at the image server from the browser on the client device.

In block 312, the edited image is saved at the image server. Saving the edited image at the image server may allow the image server to group all edited images with corresponding original images so that all images corresponding to the same original image can be presented together to present a visual conversation or commentary on the original image to users. Saving the edited image at the image server may also allow the image server to provide the edited image for editing by other users, rather than providing the original image.

In some embodiments, the method 300 may additionally include sharing the edited image on a social network hosted by the image server when the first website is a website unassociated with a social network. Alternately, the method 300 may additionally include sharing the edited image on a social network hosted by a server that also hosts the first website when the first website is a website associated with the social network.

The browser may be a first browser, the client device may be a first client device and the edited image may be a first edited image. In these and other embodiments, the method 300 may alternately or additionally include receiving a request from a second browser on a second client device to edit the image or the edited image. The second browser may be redirected to the second website including the image or the first edited image and the browser-based UI for editing the image or the first edited image to generate a second edited image. The second edited image may be received at the image server from the second browser on the second client device and may be saved at the image server. Thus, multiple users may edit a photo or other image and create a visual comment stream with respect to the image, e.g., in the form of multiple edited images, as opposed to being limited to commenting on images in a primarily textual manner as in some social networks.

Some embodiments disclosed herein include an article of manufacture such as a computer storage medium having instructions stored thereon that are executable by a computing device to perform operations included in the method 300 of FIG. 3A, such as the operations illustrated by blocks 302, 304, 306, 308, 310 and/or 312 in FIG. 3A, and/or variations thereof. The computer storage medium may be included in the image server 101 and may include the storage medium 101B, for example. The computing device may include the image server 101, and/or a processor or other processing device of the image server 101, such as the processor 101A.

FIG. 3B shows an example flow diagram of a method 350 of creating visual conversations, arranged in accordance with at least some embodiments described herein. The method 350 may be performed in whole or in part by, e.g., the image server 101 of FIG. 1 and/or the social network 103 including servers of the social network 103. Although illustrated as discrete blocks, various blocks may be divided into additional blocks, combined into fewer blocks, or eliminated, depending on the desired implementation.

The method 350 may begin at block 352 in which an image is received from a first user. More particularly, the image may be received from a client device associated with the first user, such as the client device 104 of FIG. 1. The image may be received at a social network in some embodiments, such as the social network 103 or a social network hosted by the image server 101.

The image may include an original image, e.g., an unedited image that may have been downloaded or otherwise saved to the client device previously or that may have been captured by a camera of the client device, or the like or any combination thereof.

Alternately or additionally, the image may include an edited image such as an edited version of an original image stored locally on the client device associated with the first user and/or an edited version of an original image captured by a camera of the client device. Moreover, the image may be generated by the first user editing the original image using a browser, a native app, or other suitable application on the client device as described herein.

Alternately or additionally, the image may include an edited image such as an edited version of an original image pulled from a source location into a browser, a native app, or other suitable application running on the client device. The original image may be edited in the browser, the native app, or other suitable application to create the image.

In block 354, the image may be shared with other users. For example, where the image is received at a social network, the image may be shared with other users, such as members of the social network that are associated with the first user, by sharing the image on a wall, a timeline, a feed, in a comment stream of a corresponding original image, or via other sharing means of the social network.

In block 356, a visual comment stream for the image is received from at least some of the users. The visual comment stream may include at least one edited image corresponding to the image. For example, the users may generate edited images corresponding to the image by editing and sharing the image as described herein.

In block 358, the visual comment stream may be shared with the users. For example, the visual comment stream may be shared in the form of comment stream of the image, with the at least one edited image appearing in the comment stream of the image. Alternately or additionally, the image and the at least one edited image corresponding to the image may be included in a website that displays the image and corresponding edited images together.

Some embodiments disclosed herein include an article of manufacture such as a computer storage medium having instructions stored thereon that are executable by a computing device to perform operations included in the method 350 of FIG. 3B, such as the operations illustrated by blocks 352, 354, 356 and/or 358 in FIG. 3B, and/or variations thereof. The computer storage medium may be included in the image server 101 and may include the storage medium 101B, for example, or may be included in the social network 103 or a server thereof. The computing device may include the image server 101 or a server of the social network 103, and/or a processor or other processing device of the image server 101 or the server of the social network 103, such as the processor 101A.

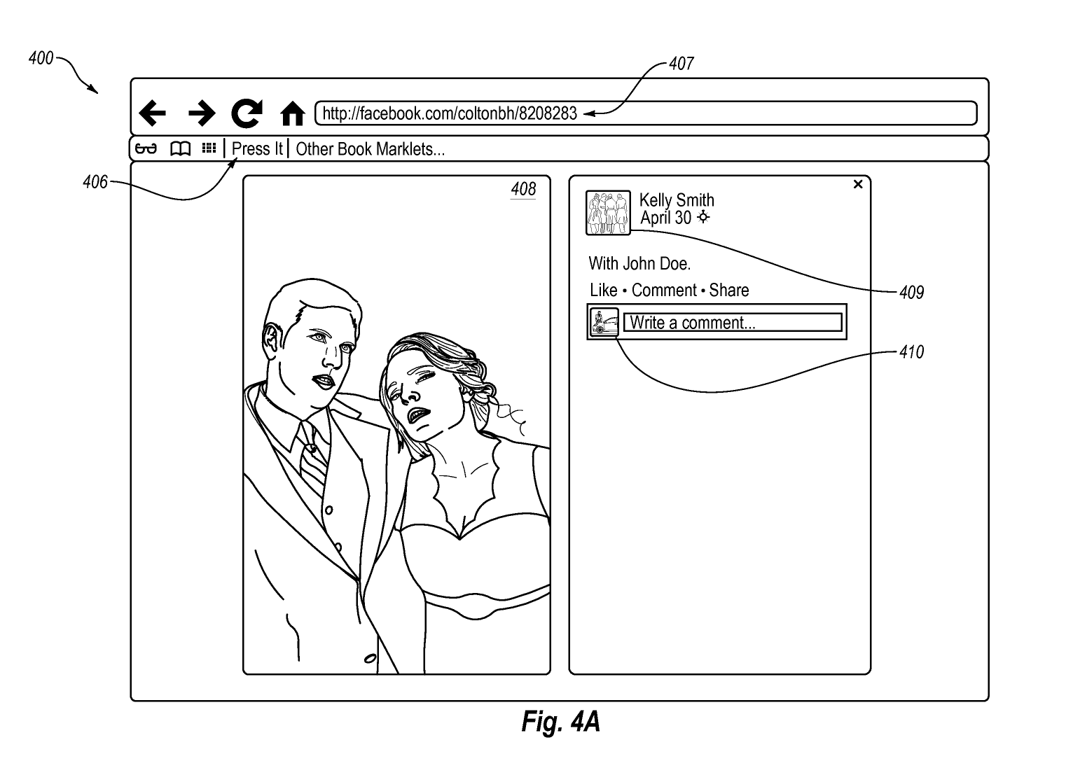

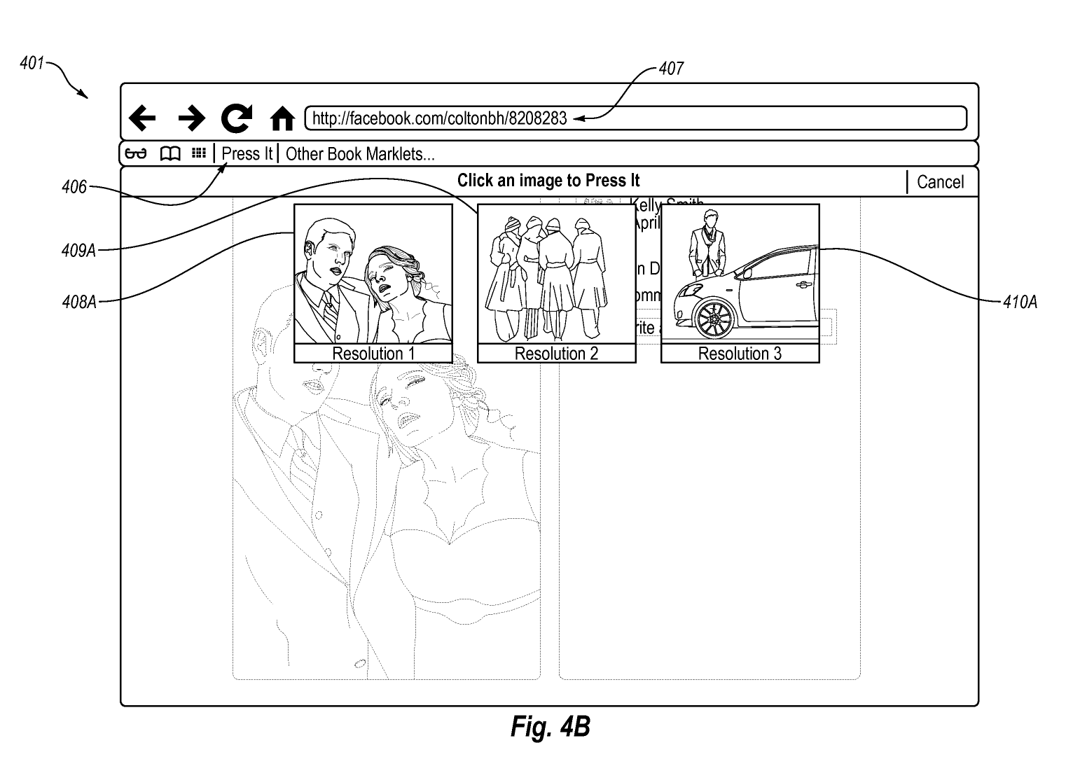

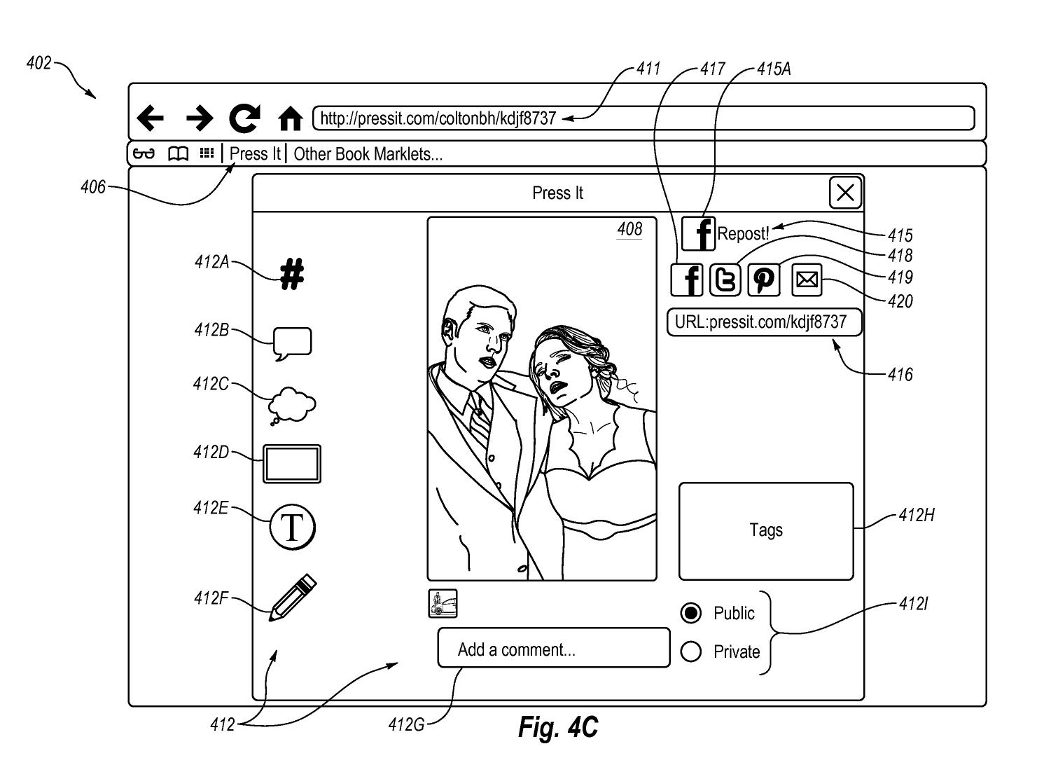

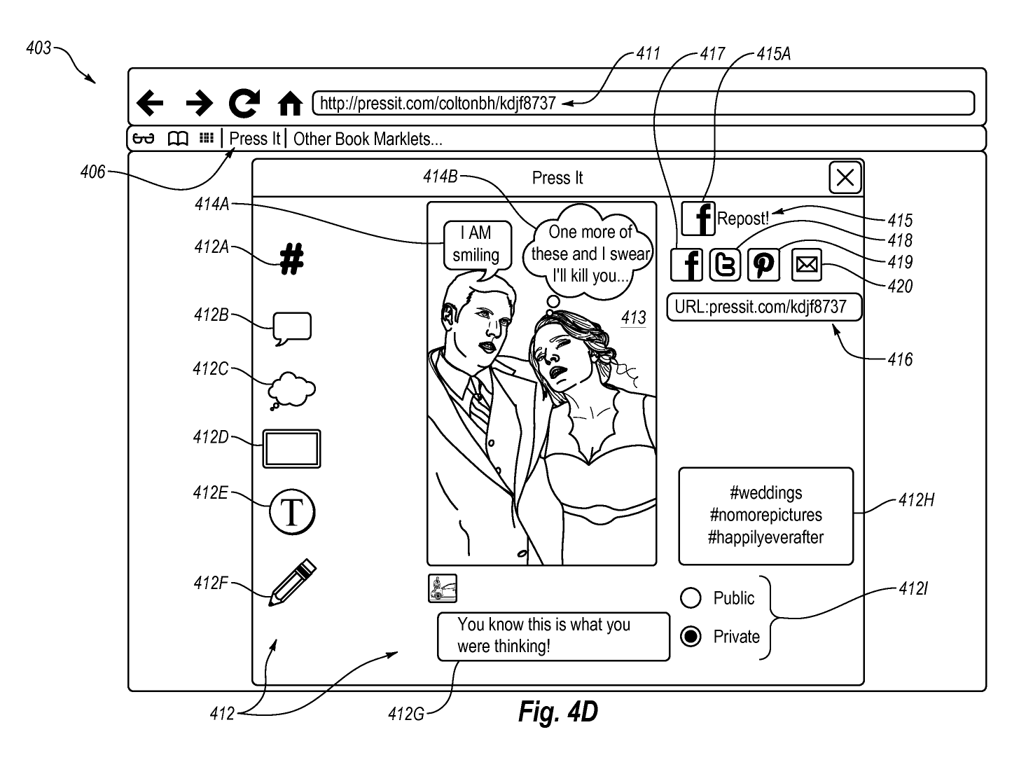

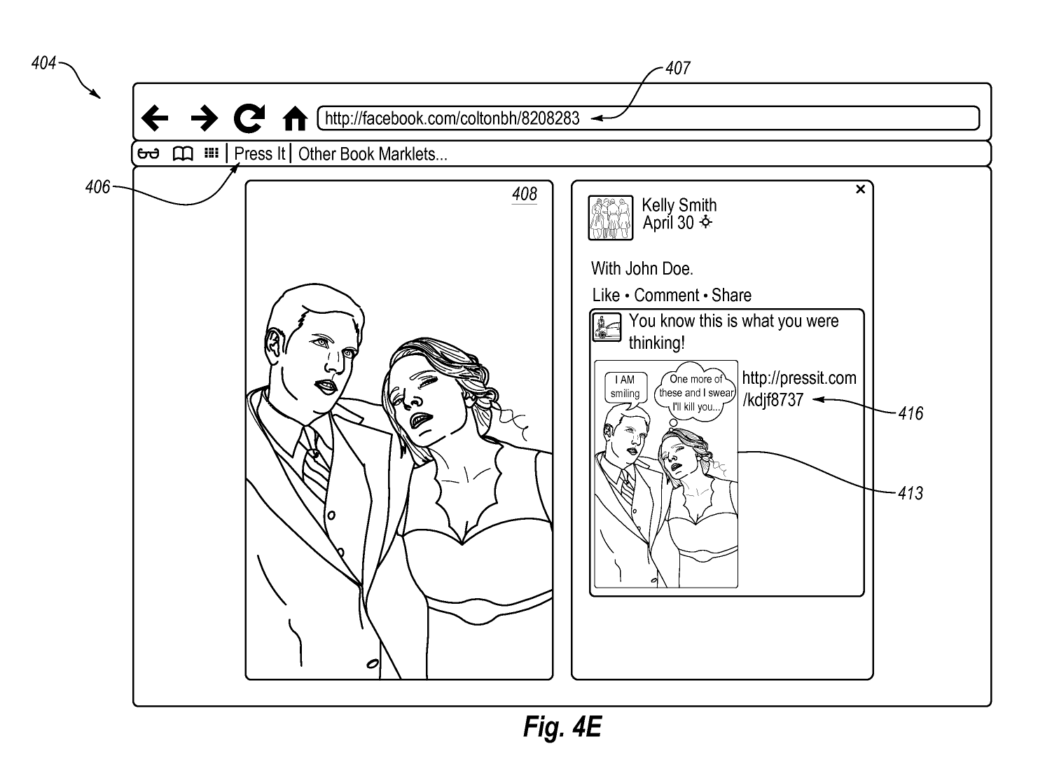

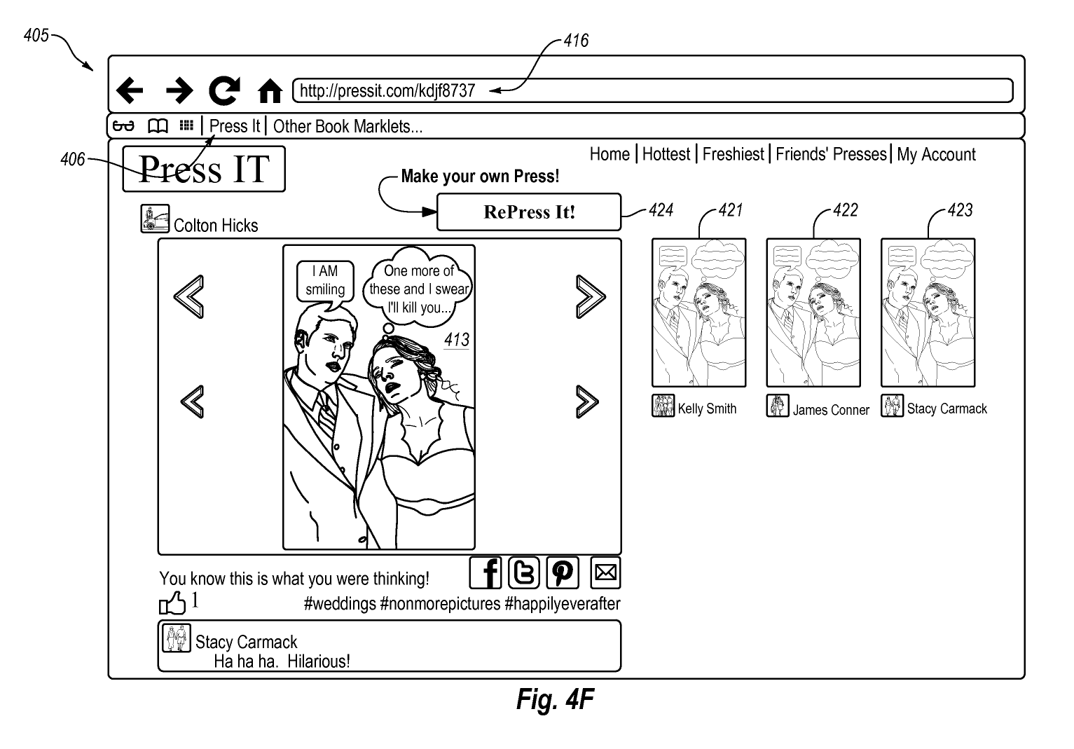

FIGS. 4A-4F include a first set of screenshots 400-405 that illustrate aspects of a specific embodiment of the methods of FIGS. 2-3B, arranged in accordance with at least some embodiments described herein. Each of the screenshots 400-405 illustrates an example browser with various UI elements (not labeled) for controlling the browser, including a back button, a forward button, a refresh button, a home page button, and a URI field. The operation of the foregoing UI elements and/or UI elements analogous thereto is known in the art and is not described in further detail to avoid obscuring the invention. Generally, the functions associated with these and other UI elements as described herein may be invoked by a user operating an input device to provide appropriate input, such as clicking on the UI element using a mouse or touchscreen display of a client device, such as the client device 104, on which the browser is running. The browser in the screenshots 400-405 of FIGS. 4A-4F additionally includes a first book marklet 406, described in more detail below.

With combined reference to FIGS. 1-4F, a specific embodiment of the methods 200, 300 will now be described. A first website designated by the URI 407 in the URI field of FIG. 4A may be rendered in the browser 104A. The first website may be part of a social network 103, such as Facebook in the illustrated embodiment. The first website includes multiple images 408-410 which may correspond to the original image(s) 103A of FIG. 1.

If the user desires to edit one of the images 408-410 from the first website in the screenshot 400 of FIG. 4A, the user can provide user input effective to request that the desired image be edited. For example, the user can select the first book marklet 406. Selection of the first book marklet 406 may invoke a JavaScript that, when executed, identifies all of the images 408-410 in the first website and, as illustrated in the screenshot 401 of FIG. 4B, displays representations 408A, 409A, 410A, such as tiles or thumbnails, of the corresponding images 408-410 in the browser 104A. The representations 408A, 409A, 410A may be overlaid over the first website as illustrated. In some embodiments, the first website may be at least partially obscured or hidden, or displayed in some other manner indicating the first website is in a background and the representations 408A, 409A, 410A are in a foreground. Optionally, each of the representations 408A, 409A, 410A may identify a resolution of the corresponding image 408-410, such as “Resolution 1”, “Resolution 2” and “Resolution 3” in FIG. 4B. The user may then provide user input effective to select one of the representations 408A, 409A, 410A of the images 408-410. For example, the user may click on the representation 408A, 409A, 410A corresponding to the desired image, such as the representation 408A corresponding to the image 408 in the discussion that follows.

In other embodiments where the source location of the image that is to be edited is a local storage medium or a camera of the client device, the application used to edit and share the images may allow the user to navigate a local file system to one or more images, or to automatically open the editing and sharing application with an image captured by the camera, or the like.

Returning to FIG. 4B, selection by the user of the representation 408A corresponding to the image 408 may additionally redirect the browser 104A from the source location of the first website to the image server 101. For example, selection by the user of the representation 408A may cause the JavaScript to send a request to the image server 101 that includes the URI 407 of the first website and an identification of the image 408 and to redirect the browser 104A to the image server 101.

The image server 101 may retrieve the image 408 from the first website using the URI 407 included in the request and may save the image 408. The image server 101 may additionally serve a second website to the browser 104A, effectively redirecting the browser 104A to the second website as designated by the URI 411 in the URI field of FIG. 4C. An example of how the second website may be rendered in the browser 104A is illustrated in FIG. 4C. The second website received from the image server 101 includes the image 408 and a browser-based UI 412 for editing the image 408.

The browser-based UI 412 may allow the user to add content to the image 408 using any of buttons 412A-412F. For instance, the button 412A may be selected to view one or more pre-populated thought bubbles and/or speech bubbles that can be selected and positioned at a desired location on the image 408. The pre-populated bubbles may be pre-populated with popular phrases or other text that is used frequently by users in editing images, for instance. In some embodiments, the user can resize the bubble by clicking and dragging an edge or corner of the bubble, or move the position of the tail (in the case of a speech bubble) or bubble chain (in the case of a thought bubble) along the perimeter of the bubble by clicking and dragging on the tail or bubble chain, or providing other appropriate user input.

The button 412B may be selected to add an empty speech bubble to the image 408, while the button 412C may be selected to add an empty thought bubble to the image 408. The bubbles may be moved to any desired location on the image 408, resized, have the tail or bubble chain moved, or the like or any combination thereof, as already described with respect to the pre-populated bubbles. The user may additionally click or otherwise select a location within the bubble to add text inside the bubble and may be able to configure the text with a desired font, color, size, or other characteristic of the text.

The button 412D may be selected to add a border or frame to the image 408. Optionally, the user may select from any one of multiple different borders or frames after selecting the button 412D.

The button 412E may be selected to add text to the image 408 without having the text enclosed within a speech or thought bubble. The text may be moved to any desired location on the image 408 and may be configured with a desired font, color, size, or other characteristics.

The button 412F may be selected to draw lines or to freehand draw or place other objects on the image 408. Examples of objects the user may draw or place on the image 408 may include, but are not limited to, circles, polygons, spheres, boxes, cylinders and other 2D or 3D geometric shapes, freehand shapes, connectors, block arrows, symbols, clipart, or the like or any combination thereof. The user may be able to configure any lines or other objects drawn on the image 408 with a desired color, thickness, or other characteristic, similar to other drawing tools known to those of ordinary skill in the art.

The browser-based UI 412 may alternately or additionally include a comment field 412G, a tag field 412H, and/or a public/private designator 412I. In the comment field 412G, the user may add a comment or other text that appears near or next to the edited image when shared.

In the tag field 412H, the user may add one or more hashtags.

The user may toggle between a Public option and a Private option using the public/private designator 412I. Selection of the Private option limits who can see the edited image, while selection of the Public option does not limit who can see the edited image beyond any limits already in place in the social network to which the edited image is shared.

The buttons 412A-412F, the comment field 412G, the tag field 412H and the public/private designator 412I are all examples of image editing elements 412A-412I that may be included in the browser-based UI 412. Similar and/or different image editing elements may be provided in a native app or other application used for editing and sharing images as described herein. Modifications may be made to the browser-based UI 412—or to an app-based or application-based UI—without departing from the scope of the described embodiments. For example, the browser-based UI 412 may include more or fewer image editing elements 412A-412I than illustrated in FIG. 4C. Alternately or additionally, other image editing elements may be provided, such as a button that pre-populates block letters in predetermined locations of the image 408 to create an Internet meme and/or with pre-populated phrases or other text corresponding to one or more popular Internet memes, or a button for cropping the image 408, a button for modifying an aspect ratio of the image 408, or buttons for performing other editing operations on the image 408.

Accordingly, the browser-based UI 412 may be used to edit the image 408, resulting in an edited image 413 as shown in the screenshot 403 of FIG. 4D. As illustrated, the edited image 413 includes a speech bubble 414A, a thought bubble 414B, a comment in the comment field 412G, and various hashtags in the tag field 412H. The foregoing edits are provided by way of example only and more, fewer, or different edits can be performed in other embodiments.

When the user is finished editing, the edited image 413 can be shared back to the social network 103 from which the image 408 was pulled by selecting a repost button 415. As noted previously, the social network 103 from which the image 408 is pulled is Facebook in the present example, and the repost button 415 may include an icon 415A corresponding to Facebook. More generally, the repost button 415 in some embodiments may include an icon corresponding to the social network 103, whichever it may be, from which the image 408 is pulled. Reposting the edited image 413 may share the edited image 413 to the social network 103, e.g., Facebook in this example, by posting the edited image 413 and/or a URI 416 of the edited image 413 to a comments section of the original image 408 in the first website to which the browser 104A is redirected after selection of the repost button 415, as illustrated in FIG. 4E.

The edited image 413 may additionally be sent to the image server 101 where the edited image 413 is saved. The URI 416 of the edited image 413 may be hosted by the image server 101.

Returning to FIG. 4D, rather than reposting the edited image 413, the edited image 413 may be shared to other social networks than the one from which the original image 408 was pulled, or in other manners than posting to the comments section of the original image 408, by selecting a corresponding one of buttons 417-420. For instance, selecting the button 417 may share the edited image 413 to Facebook by, e.g., posting the edited image 413 and/or the URI 416 to the user's Facebook wall or timeline. Selecting the button 418 may share the edited image 413 to Twitter by, e.g., tweeting the URI 416 to the user's Twitter feed. Selecting the button 419 may share the edited image 413 to Pinterest by, e.g., posting the edited image 413 and/or the URI 416 to the user's Pinterest pinboard. Selecting the button 420 may generate an email with the edited image 413 as an attachment and/or including the URI 416 somewhere in the email such that the user can share the edited image 413 via email.

As illustrated in FIG. 4E, some embodiments described herein allow users to make comment streams for posted images, such as the image 408, to become more visual. In particular, edited versions of the posted images, such as the edited image 413, can be posted to the comment stream of the posted images, creating a more artistic and visual experience than having a posted image and separate comments that are primarily textual in nature. Other users may edit the original image 408 or the edited image 413 in the manner already described and may share additional edited images 413 to create a running visual commentary.

All of the edited images corresponding to an original image, as well as the original image, may be saved by the image server 101. Thus, when a second user selects an edited image, such as the edited image 413, or a corresponding URI, such as the URI 416, from the first website or other website where the edited image has been shared, the second user may be redirected to a corresponding website included in a social network hosted by the image server 101 such as is illustrated in the screenshot 405 of FIG. 4F. As shown in FIG. 4F, the selected edited image 413 may be displayed prominently with one or more other edited images 420-422 corresponding to the original image 408 also displayed on the website. Optionally, the original image 408 may also be displayed (not shown). The second user may then select for editing the original image 408 and/or any of the edited images 413, or 421-423 by selecting a button 424 that causes the browser 104A to send the selected image and the browser-based UI 412 described above to the browser of the second user. The second user may delete or modify any existing edits and/or add new edits when editing a previously edited image, and/or may add new edits when editing the original image using the browser-based UI 412 as already described above.

Accordingly, embodiments of the invention allow multiple users to share and comment on images, including photos, and to interact with each other in a more visual manner, creating visual conversations between such users. In these and other embodiments, a server such as the image server 101 and/or the social network 103 may host websites with one or more original image(s) 101C, 103A. A first user may select one of the original image(s) 101C, 103A to edit and share via a social network, or may select an image locally, such as from local storage or a new image from a camera. The first user may edit and share the selected image using a browser, a native app, or other suitable application. The selected image may be edited and the edited image may be shared to the social network 103 and/or to a social network hosted by the image server 101. Other users, in response to viewing the edited image, can engage in a visual commentary with respect to the image by also editing and sharing the same image back to the social network 103 and/or the social network hosted by the image server 101, for example.

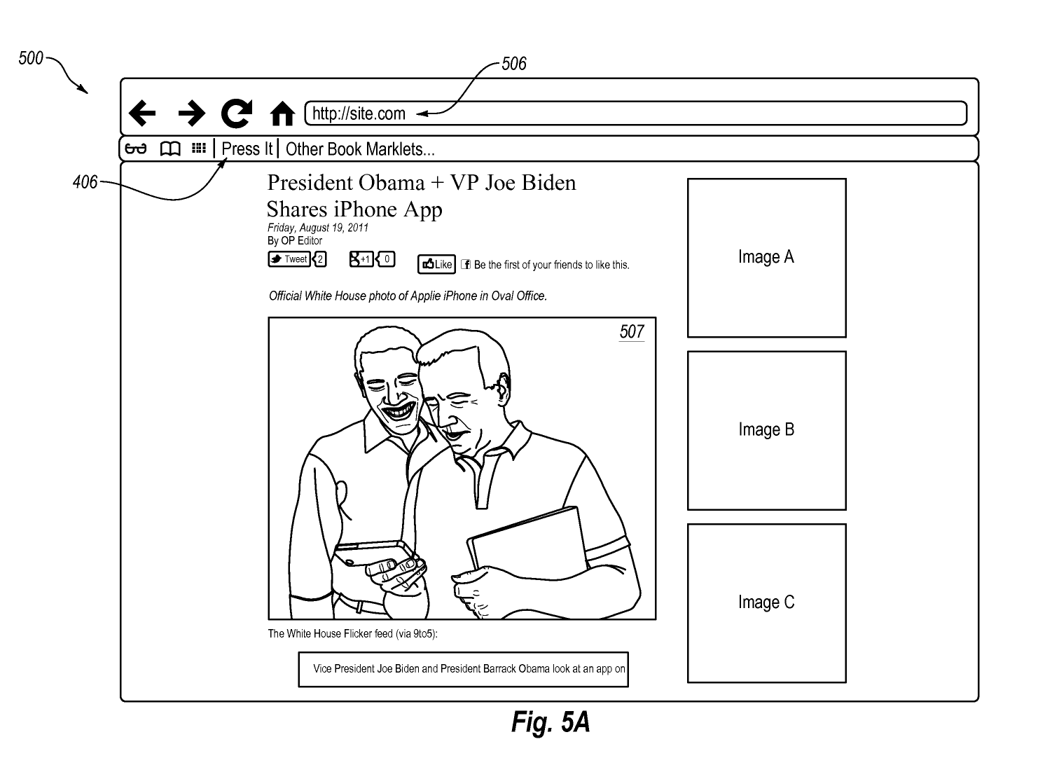

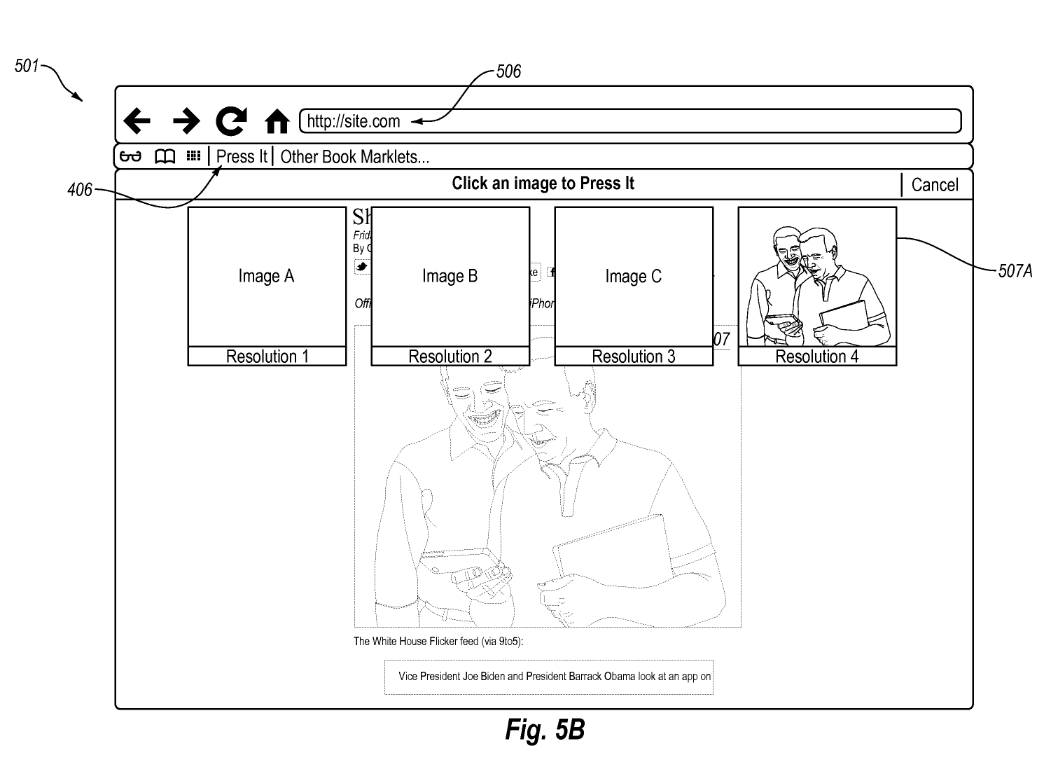

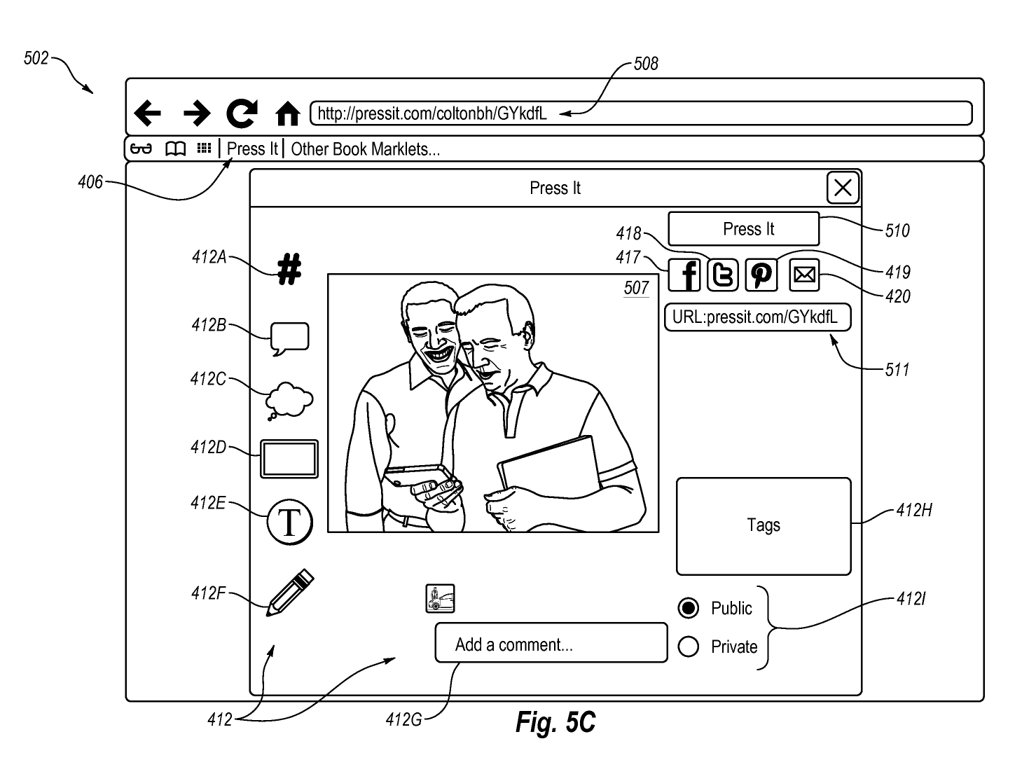

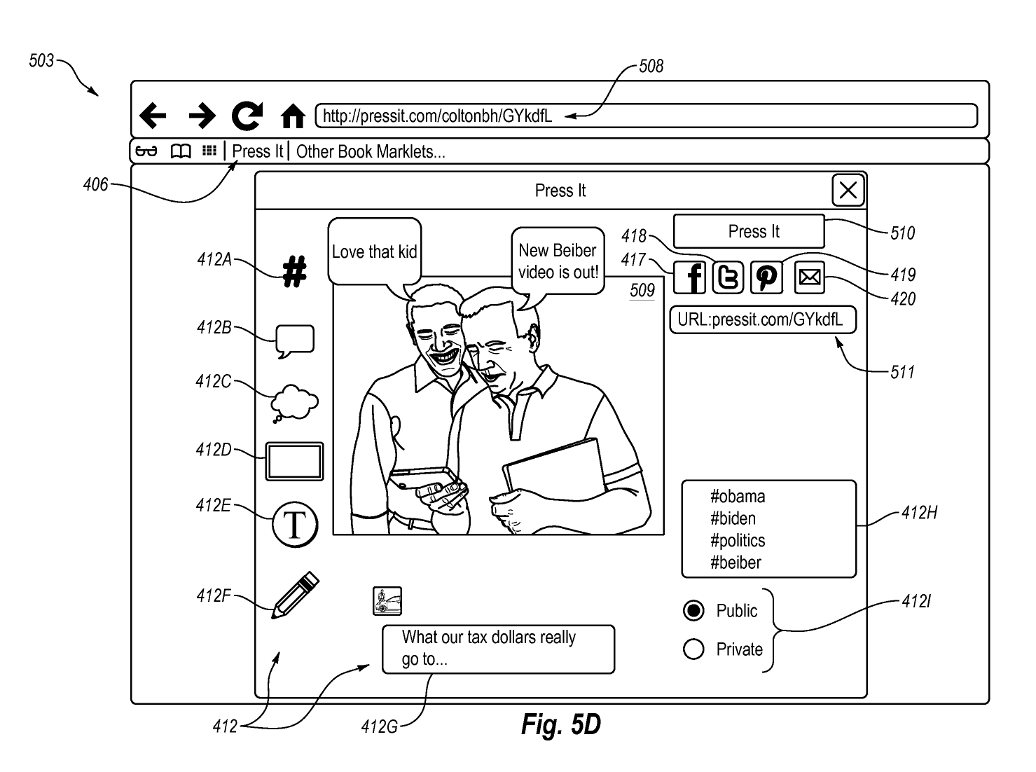

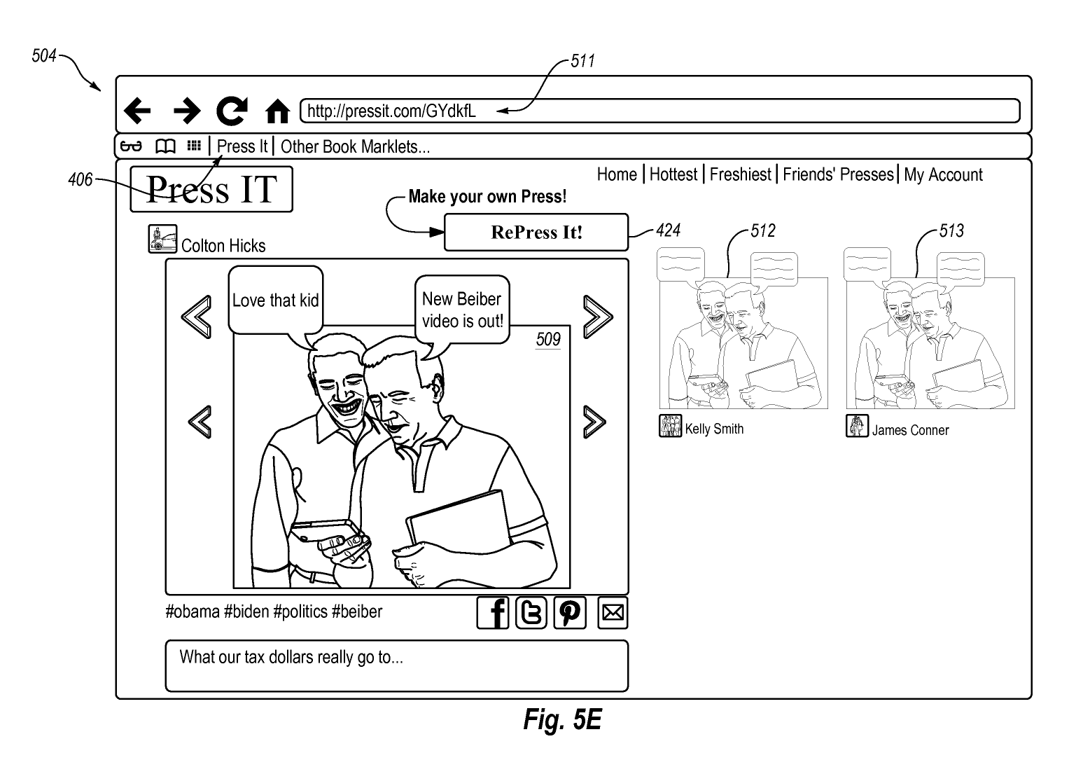

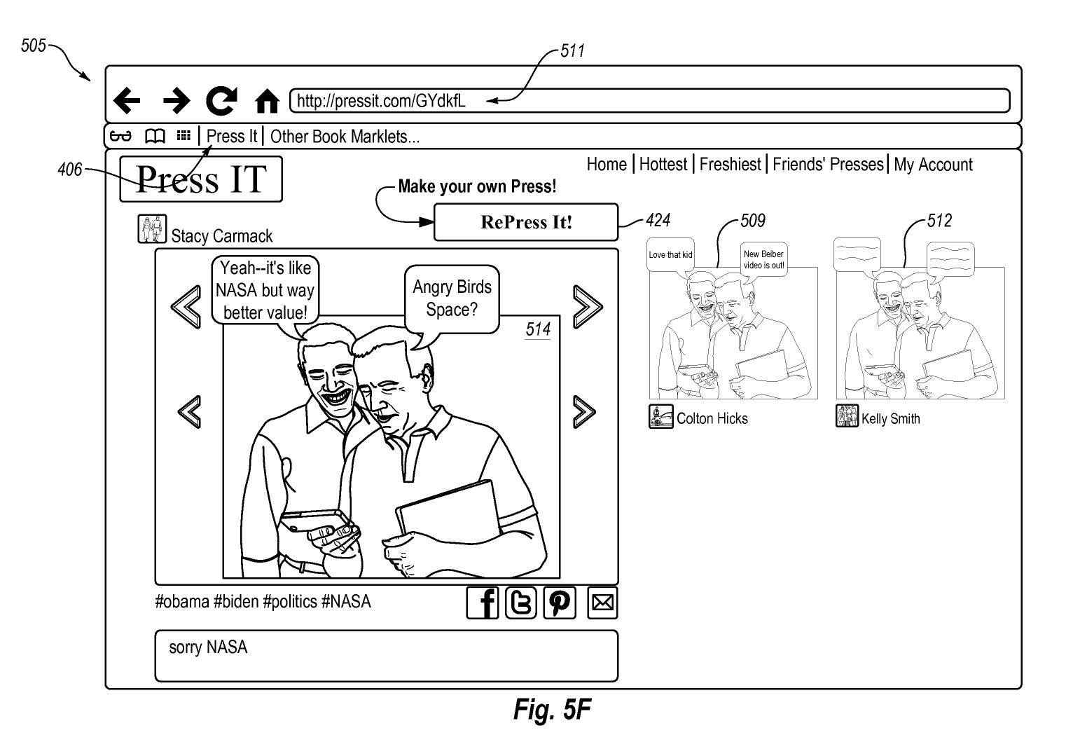

FIGS. 5A-5F include a second set of screenshots 501-506 that illustrate another specific embodiment of the method of FIG. 2, arranged in accordance with at least some embodiments described herein. The browser of FIGS. 5A-5F includes many of the same UI elements as the browser of FIGS. 5A-5F, such as the UI elements for controlling the browser and the first book marklet 406.

With combined reference to FIGS. 1-3B and 5A-5F, and similar to the description provided with respect to FIGS. 4A-4F, the browser 104A initially renders a first website as designated by the URI 506. However, the first website is hosted by the web server 102 or another server not associated with a social network. The user can request that an image 507 in the first website be edited by selecting the first book marklet 406 to invoke the JavaScript that identifies and displays representations of multiple images included in the first website as illustrated in FIG. 5B. The user in the present example selects a representation 507A corresponding to the image 507 as described above.

The browser 104A may be redirected from the source location of the first website to the image server 101 by sending a request to the image server 101 that includes the URI 506 of the first website and an identification of the image 507. The image server 101 may retrieve the image 507 from the first website using the URI 506 included in the request, may save the image 507, and may serve a second website to the browser 104A, effectively redirecting the browser 104A from the first website to the second website designated by a URI 508 in the URI field of FIG. 5C. The second website received from the image server 101 includes the image 507 and the browser-based UI 412 (and/or variations thereof) described above for editing the image 507. The browser-based UI 412 may be used to edit the image 507, resulting in an edited image 509 as shown in the screenshot 503 of FIG. 5D.

In the present example, the original image 507 is pulled from the first website that is not associated with a social network. As such, rather than including the repost button 415 described above, the browser-based UI 412 includes a button 510 for posting the edited image 509 to the social network hosted by the image server 101. The browser-based UI 412 may additionally display a URI 511 of the edited image 507 at the image server 101. The buttons 417-420 provide other ways for the user to share the edited image 507 as described above.

The screenshot 504 of FIG. 5E illustrates an example of the edited image 509 in a website of the social network hosted by the image server 101, as well as other edited images 512, 513 corresponding to the original image 507. A second user may select the button 424 of FIG. 5E to select for editing any of the edited images 509, 512, 513 and/or the corresponding original image 507 to generate another edited image 514 as illustrated in the screenshot 505 of FIG. 5F. Thus, users can engage in a visual dialogue or commentary by editing images that have already been edited where the edited images are presented together as illustrated in FIG. 5F. The ability to edit images and share edited images is an advancement over some social networks where comments are limited to textual comments, as users can express their comments and responses in a more artistic and/or visual form than is permitted by textual comments.

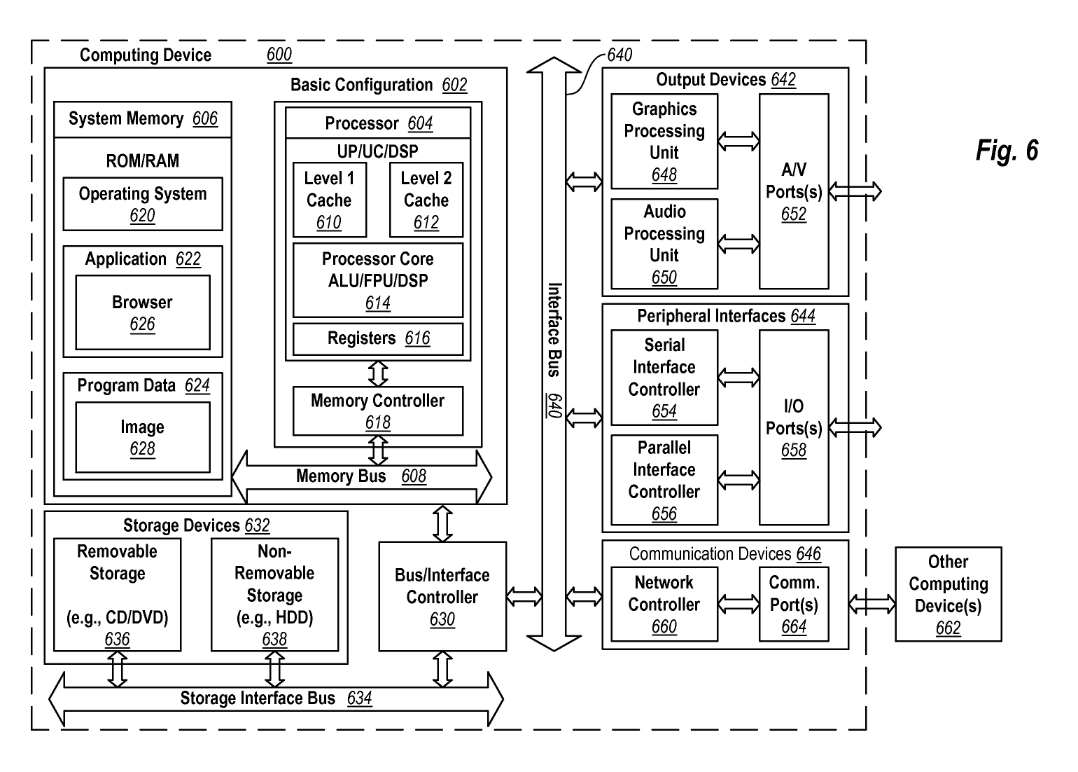

FIG. 6 is a block diagram illustrating an example computing device that is arranged for editing and sharing images, in accordance with at least some embodiments described herein. The computing device 600 may be included in or correspond to any of the client devices 104-106 and/or the image server 101 of FIG. 1, for example. In a very basic configuration 602, the computing device 600 typically includes one or more processors 604 and a system memory 606. A memory bus 608 may be used for communicating between the processor 604 and the system memory 606.

Depending on the desired configuration, the processor 604 may be of any type including but not limited to a μP, a μC, a DSP, or any combination thereof. The processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an OS 620, one or more applications 622, and program data 624. The application 622 may include a browser 626, an app, an application server, or other application that is arranged to perform one or more of the functions as described herein including those described with respect to the methods 200, 300 and/or 350 of FIGS. 2-3B. The program data 624 may include an image 628 that may be pulled into the browser 626 for editing and sharing on one of the client devices 104-106 of FIG. 1, for example. In some embodiments, the application 622 may be arranged to operate with the program data 624 on the OS 620 such that implementations of methods for editing and sharing images and/or for creating visual conversations such as the methods 200, 300 and 350 of FIGS. 2-3B may be provided as described herein.

The computing device 600 may have additional features or functionality, and additional interfaces to facilitate communications between the basic configuration 602 and any required devices and interfaces. For example, a bus/interface controller 630 may be used to facilitate communications between the basic configuration 602 and one or more data storage devices 632 via a storage interface bus 634. The data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., output devices 642, peripheral interfaces 644, and communication devices 646) to the basic configuration 602 via the bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 600 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of editing and sharing images, the method comprising:
pulling an image from a source location into a browser executing on a client device;
editing the image within the browser; and
sharing the edited image from the browser to a social network accessible to the client device.

2. The method of claim 1, wherein editing the image within the browser includes at least one of:
adding a thought bubble, a speech bubble, text, a caption, a hashtag, a border, a mark representing user input, or a graphical object to the image;
removing a thought bubble, a speech bubble, text, a caption, a hashtag, a border, a mark representing user input, or a graphical object added to the image previously;
modifying a thought bubble, a speech bubble, text, a caption, a hashtag, a border, a mark representing user input, or a graphical object added to the image previously;
cropping the image; or
modifying an aspect ratio of the image.

3. The method of claim 1, further comprising:
prior to pulling the image, rendering in the browser a website received from the source location, the website including the image;
receiving user input effective to request that the image be edited;
communicating the request to an image server, wherein the image server is configured to save a first copy of the image and forward a second copy of the image to the client device.

4. The method of claim 3, further comprising sending a copy of the edited image to the image server for storage on the image server.

5. The method of claim 3, wherein:
the image comprises a first image;
the website comprises a first website including a plurality of images;
receiving user input effective to request that the first image be edited comprises:
receiving user input effective to run a JavaScript, the JavaScript being configured to identify the plurality of images and display representations of the plurality of images in the browser; and
receiving user input effective to select one of the representations corresponding to the first image and to redirect the browser from the source location to the image server; and
the method further comprises:
receiving a second website from the image server including the first image and a browser-based user interface for editing the first image;
rendering the second website received from the image server in the browser; and
receiving user input effective to edit the first image.

6. The method of claim 3, wherein the social network is hosted by the image server.

7. The method of claim 1, wherein the social network comprises the source location.

8. The method of claim 1, wherein the source location comprises a website including a plurality of edited images all corresponding to the image, the plurality of edited images created by a plurality of users and forming a visual comment stream associated with the image.

9. An article of manufacture comprising a computer storage medium having computer instructions stored thereon that are executable by a computing device to perform the method of claim 1.

10. A method of editing and sharing images, the method comprising:
receiving a request from a browser on a client device to edit an image included in a first website rendered by the browser, the request including a Uniform Resource Identifier (URI) of the first website and an identifier of the image;
retrieving the image from the first website using the URI and the identifier;
saving the image;
redirecting the browser to a second website including the image and a browser-based user interface for editing the image, wherein the image is edited at the client device in the browser;
receiving the edited image from the browser on the client device; and
saving the edited image at an image server.

11. The method of claim 10, further comprising sharing the edited image on a social network hosted by the image server when the first website is a website unassociated with a social network.

12. The method of claim 10, further comprising sharing the edited image on a social network hosted by a server that also hosts the first website when the first website is a website associated with the social network.

13. The method of claim 10, wherein the browser comprises a first browser, the client device comprises a first client device and the edited image comprises a first edited image, the method further comprising:
receiving a request from a second browser on a second client device to edit the image or the edited image;
redirecting the second browser to the second website including the image or the first edited image and the browser-based user interface for editing the image or the first edited image to generate a second edited image;
receiving the second edited image from the second browser on the second client device; and
saving the second edited image at the image server.

14. The method of claim 10, wherein the image has a format selected from a group including Joint Photographic Experts Group (JPEG) format, JPEG File Interchange Format (JFIF), JPEG 2000 format, Exchangeable image file format (Exif), Tagged Image File Format (TIFF), Portable Network Graphics (PNG) file format, Graphics Interchange Format (GIF), BMP file format, portable pixmap (PPM) file format, portable graymap (PGM) file format, portable bitmap (PBM) file format, Computer Graphics Metafile (CGM) file format, RS-274X Extended Gerber Format, and Scalable Vector Graphics (SVG) format.

15. An article of manufacture comprising a computer storage medium having computer instructions stored thereon that are executable by a computing device to perform the method of claim 10.

16. A method of creating visual conversations, the method comprising:
receiving an image from a first user;
sharing the image with other users;
receiving a visual comment stream for the image from at least some of the other users, the visual comment stream comprising at least one edited image corresponding to the image; and
sharing the visual comment stream with the users.

17. The method of claim 16, wherein the image received from the first user comprises an edited version of an original image stored locally on a client device associated with the first user and/or an edited version of an original image captured by a camera of the client device, the image being generated by the first user editing the original image using a native app on the client device.

18. The method of claim 16, wherein the image received from the first user comprises an edited version of an original image pulled from a source location into a browser running on a client device associated with the user, the original image being edited in the browser on the client device to create the image.

19. The method of claim 16, wherein the image and the visual comment stream are received and shared by one or more servers of a social network.

20. An article of manufacture comprising a computer storage medium having computer instructions stored thereon that are executable by a computing device to perform the method of claim 16.
